(19) United States
(12) Patent Application Publication
(10) Pub. No.: US 2026/0189953 A1
(43) Pub. Date: Jul. 2, 2026

(54) Enhancement on Inter-Frequency Measurement with Need for Gap (NFG) and Network Controlled Small Gap (NCSG)

(71) Applicant: Apple Inc., Cupertino, CA (US)

(72) Inventors: Qiming Li, Beijing (CN); Jie Cui, San Jose, CA (US); Yang Tang, San Jose, CA (US); Dawei Zhang, Saratoga, CA (US); Haijing Hu, Los Gatos, CA (US); Yuqin Chen, Beijing (CN)

(21) Appl. No.: 18/851,643

(22) PCT Filed: Sep. 26, 2023
(86) PCT No.: PCT/CN2023/121730

§ 371 Date: Sep. 26, 2024

(51) Int. Cl. H04W 24/10; H04L 27/26; H04W 8/22; H04W 56/00

(52) U.S. Cl. CPC H04W 24/10; H04L 27/26025; H04W 8/22; H04W 56/0015

(57) ABSTRACT

A user equipment configured to identify one or more conditions for a UE to support gapless measuring for inter-frequency radio resource management (RRM) measurements of a synchronization signal block band (SSB), wherein the one or more conditions comprise a frequency separation between the target SSB and an active bandwidth part (BWP) of the UE being within a configurable threshold or a frequency separation threshold comprises the target SSB be within a channel bandwidth (CBW) of the UE; and transmit, to a next generation node B (gNB), a capability message indicating the UE supports gapless measuring for inter-frequency radio resource management (RRM) measurements of the SSB based on the identified conditions

### FIELD

Embodiments of the invention relate to wireless communications, including apparatuses, systems, and methods for radio resource management (RRM) measurement for user equipment (UE) supporting bandwidth part (BWP) without restriction in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

Bandwidth Part (BWP) without restriction (e.g., bwp-WithoutRestriction) was introduced in Rel-15 of the 3GPP standards as an optional feature. A UE that supports this feature indicates support of BWP operation without bandwidth restriction. The bandwidth restriction in terms of downlink (DL) BWP for a Primary Cell (PCell) and Primary Secondary Cell (PSCell) means that the bandwidth of a UE-specific Radio Resource Control (RRC) configured DL BWP may not include the bandwidth of Core Resource Set (CORESET) #0 (if configured) and the Synchronization Signal Block (SSB). For Secondary Cells (SCells), it means that the bandwidth of DL BWP may not include the SSB.

In addition, feature 6-1a was introduced in Rel-15 of the 3GPP standards as an optional feature. A UE that supports this feature has a component that bandwidth (BW) of UE-specific radio resource control (RRC) configured bandwidth part (BWP) may not include BW of the CORESET #0 (if present) and SSB for PCell/PSCELL (if configured) and BW of the UE-specific RRC configured BWP may not include SSB for SCell.

However, the specification support for this feature is not yet fully complete. For example, by the end of Rel-17, Radio Resource Management (RRM) requirements of Radio Link Monitoring (RLM), Beam Management (BM) and Beam Failure Detection (BFD) are applicable only if the associated reference signal (RS) is within an active BWP for the UE. Thus, there are additional details that need to be defined to fully support the BWP without restriction feature.

### SUMMARY

Embodiments relate to wireless communications, and more particularly to apparatuses, systems, and methods for an apparatus of a user equipment (UE) that comprises one or more processors configured to identify one or more conditions for which the UE is configured to support gapless measuring for inter-frequency radio resource management (RRM) measurements of a target synchronization signal block band (SSB), and transmit, to a next generation node B (gNB), a capability message indicating the UE supports gapless measuring for inter-frequency radio resource management (RRM) measurements of the target SSB based on the one or more identified conditions.

In some embodiments, the identified conditions can indicate the UE supports gapless measuring for the inter-frequency radio resource management (RRM) measurements of a target SSB, where the SSB is located in frequency within a channel bandwidth (CBW) of the UE and outside an active bandwidth part (BWP) of the UE in the CBW.

Other embodiments are related to an apparatus having processing circuitry configured to identify one or more conditions for a UE to support gapless measuring for inter-frequency radio resource management (RRM) measurements of a synchronization signal block band (SSB), wherein the one or more conditions comprise a frequency separation between the target SSB and an active bandwidth part (BWP) of the UE being within a configurable threshold or a frequency separation threshold that comprises the target SSB to be within a channel bandwidth (CBW) of the UE, and transmit, to a next generation node B (gNB), a capability message indicating that the UE supports gapless measuring for inter-frequency radio resource management (RRM) measurements of the SSB based on the identified conditions. The frequency separation is defined as a contiguous frequency range in the frequency domain which fully contains the bandwidth of the target SSB and the bandwidth of the active BWP.

Other embodiments relate to an apparatus of a next generation node B (gNB), the apparatus comprising one or more processors configured to receive, from the UE, a capability message indicating the UE supports gapless measuring for inter-frequency radio resource management (RRM) measurements of a target synchronization signal block (SSB) based on the identified conditions, wherein the capability message indicates one or more conditions for the UE to support gapless measuring for inter-frequency RRM measurements of the target SSB, wherein the one or more conditions comprise a frequency separation between the target SSB and an active bandwidth part (BWP) being within a configurable threshold or a frequency separation threshold of the target SSB, wherein the BWP and the target SSB are within a channel bandwidth of the UE.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIG. 8 illustrates an example of a device in accordance with some embodiments.

FIG. 9 illustrates an example baseband circuitry in accordance with some embodiments.

FIG. 10 illustrates an example schematic diagram of comparing legacy gap-based and enhanced gapless approaches for inter-frequency RRM measurements by a UE using Need For Gaps (NFG) and Network Controlled Small Gap (NCSG) according to some embodiments.

FIG. 11 illustrates an example schematic diagram of an adjustable UE bandwidth for gapless inter-frequency RRM measurements using NFG/NCSG according to some embodiments.

FIG. 12 illustrates data structures 1200 for NFG and NCSG for 3GPP Release 16 and Release 17 in an ASN.1 format containing 3GPP protocol elements for indicating UE support for inter-frequency RRM measurements without gaps using NFG and NCSG according to some embodiments.

FIG. 13 illustrates an example schematic diagram of frequency allocation where only a portion of the band can be measured gapless by the UE for inter-frequency RRM using NFG/NCSG according to some embodiments.

FIG. 14 illustrates example data structures 1400 for NFG and NCSG, with the introduction of new gap indication parameters in 3GPP protocols to indicate conditional UE support for inter-frequency RRM measurements without gaps using NFG and NCSG according to some embodiments.

FIG. 15 illustrates an example of configurable frequency separation threshold between an active BWP and a target SSB for conditional inter-frequency RRM measurement support using NFG/NCSG.

FIG. 16 illustrates example data structures for NFG and NCSG, with the introduction of new gap indication parameters in 3GPP protocols to indicate conditional UE support for inter-frequency RRM measurements without gaps using NFG and NCSG according to some embodiments.

FIG. 17 illustrates a method for determining a measurement gap configuration for RRM measurements according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to configuring inter-frequency RRM measurement for UEs supporting bandwidth part (BWP) without restriction.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to support gapless RRM measurements. Therefore, the UE as described herein is used to represent any appropriate type of electronic component.

The example embodiments are also described with regard to a fifth generation (5G) New Radio (NR) network that may configure a UE to perform measurements of a target SSB with no-gap and with-interruption, or no-gap and no-interruption. However, reference to a 5G NR network is merely provided for illustrative purposes. The example embodiments may be utilized with any appropriate type of network.

Throughout this description various information elements (IEs) are referred to by specific names. It should be understood that these names are only examples and the IEs carrying the information referred to throughout this description may be referred to by other names by various entities.

As described above, there are various aspects of features that still need to be defined. One option to support RLM/BM/BFD when the SSB configured for layer 1 (L1) operation is outside an active BWP of the UE is to use a larger bandwidth to cover the target SSB and the UE active BWP. A new UE capability may be introduced to indicate conditional UE support for this option.

In addition to RLM/BM/BFD, the UE may also perform other RRM measurements for mobility purposes, e.g., handover, Carrier Aggregation (CA)/Dual Connectivity (DC) management, etc. In legacy operation (e.g., Rel-15), when the target SSB configured for RRM measurement is outside the active BWP for the UE, the network has to configure a measurement gap for the UE to conduct the measurements. During the measurement gap, the UE can tune its radio frequency (RF) circuitry away from the active BWP to cover the target SSB. Thus, in this scenario, the UE cannot be scheduled during the measurement gap.

A UE that is capable of increasing the UE actual bandwidth to include an active BWP and one or more target SSBs, should be able to conduct RRM measurements on the target SSBs without a measurement gap even if the SSB is outside the UE active BWP. There are existing UE capabilities to indicate support of gapless RRM measurements, e.g., NeedForGaps and network controlled small gap (NCSG). However, if a UE wants to support NFG or NCSG for inter-frequency measurements of a target band, the UE should support NFG and NCSG for measurements on neighboring cells across the whole band. According to the current design, if a UE can only support NFG or NCSG for inter-frequency measurements within a portion of the band, the UE should not indicate support of inter-frequency measurements for the target band. A conditional support indication can be used to enable the UE to identify certain situations where the UE is capable of supporting NFG or NCSG. The example embodiments are described in greater detail below.

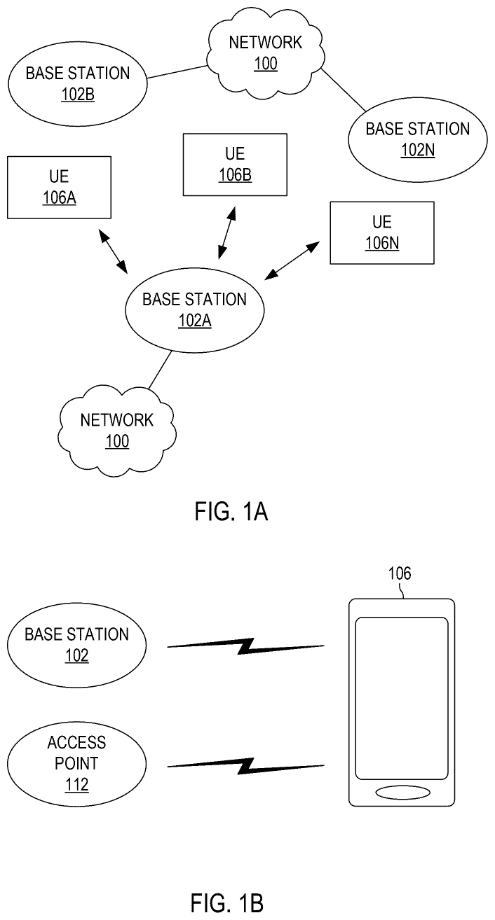

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

In some embodiments, the base stations 102 can be configured for inter-band SSB-less carrier aggregation, as further described herein. One base station 102A may be a primary cell (PCell) with a radio resource control (RRC) connection, while another base station 102N may be a secondary cell (SCell) that is configured for inter-band and non-contiguous communication without a synchronization signal block (SSB-less).

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTTor LTE or GSM), and separate radios for communicating using each of Wi-Fi and Bluetooth. Other configurations are also possible.

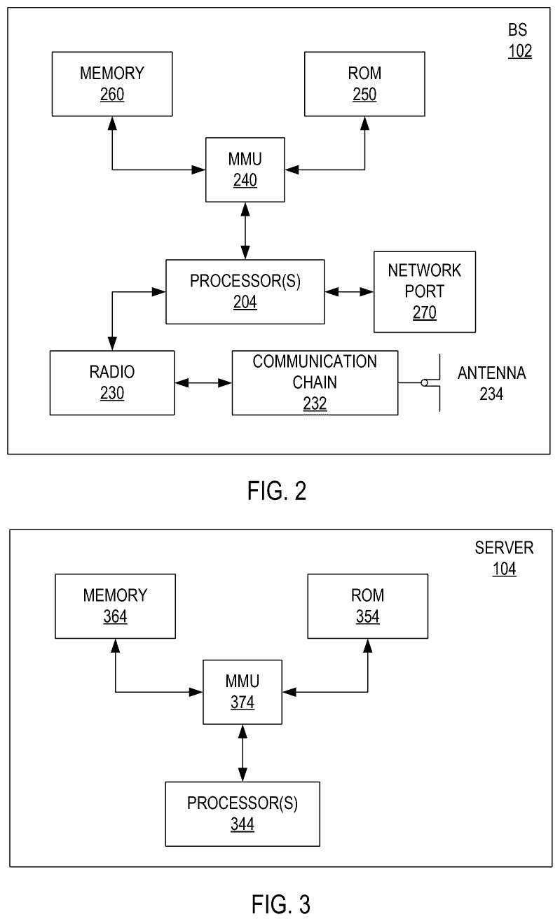

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station or gNB 102, and/or processors 204 thereof, can be capable of and configured to decode indications from the UE 106, determine UE capabilities based on the indications, and encode for transmission to the UE 106 downlink signals to enable the UE to perform measurements of an inter-frequency target SSB with no-gap based on conditional UE capability indications.

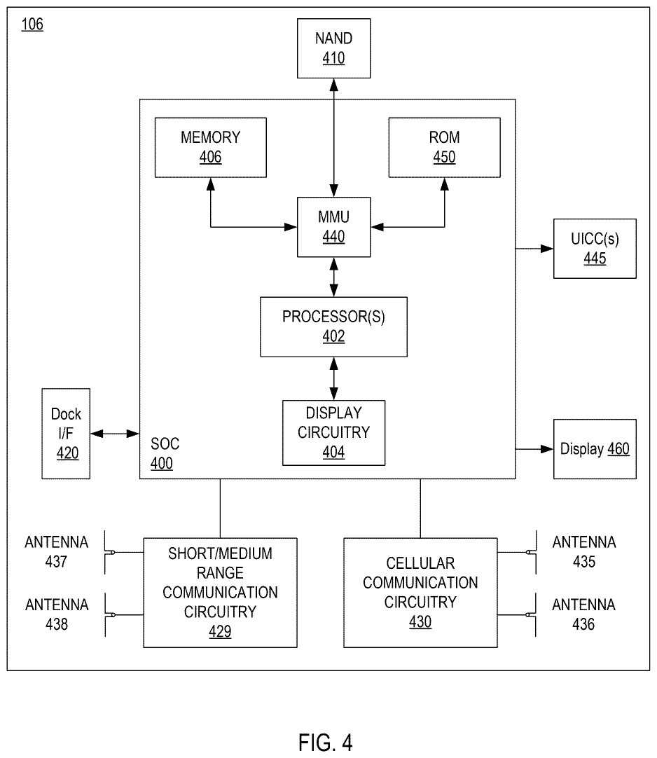

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

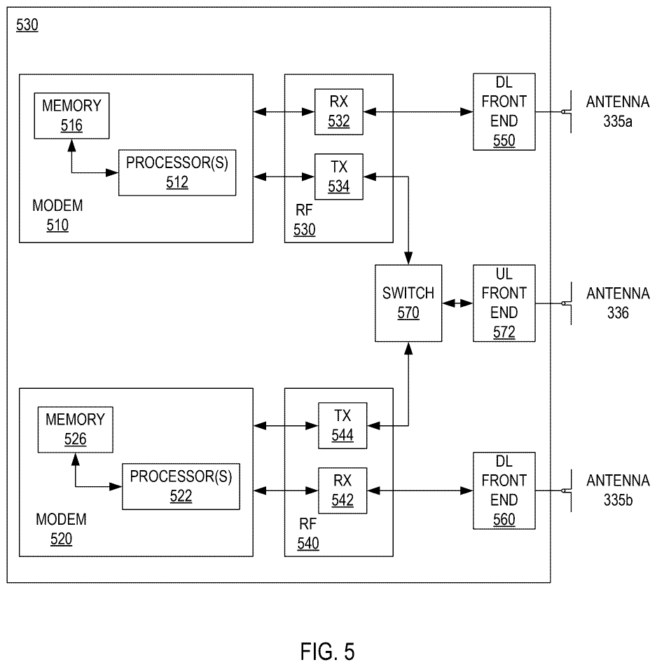

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 and processors 402 can be configured to and/or capable of performing various operations related to reporting a conditional UE capability for inter-frequency operations, to include a target SSB and perform inter-frequency measurements, as described herein.

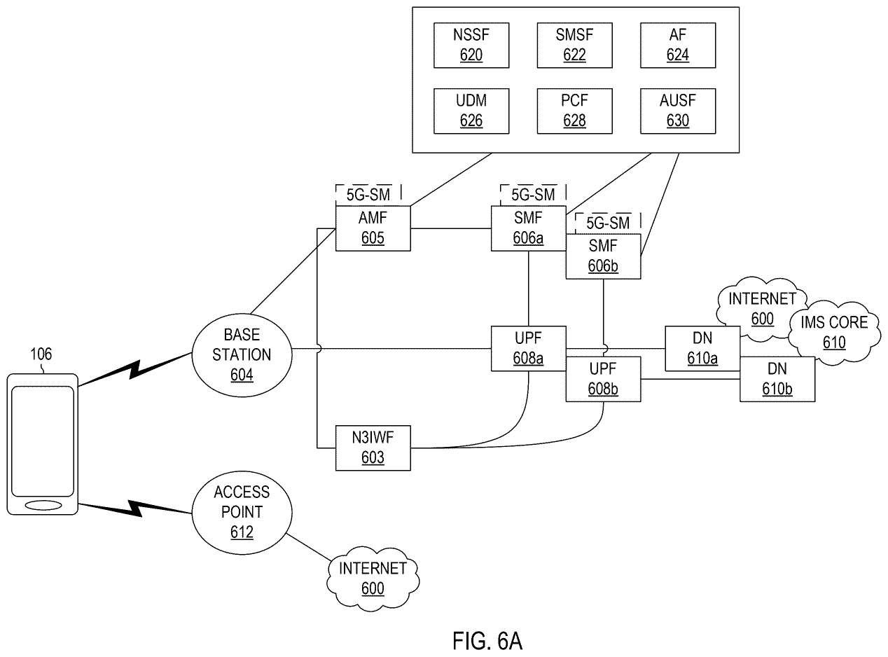

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

In some embodiments, the processors 512, 522 can be configured for inter-band SSB-less carrier aggregation, as further described herein.

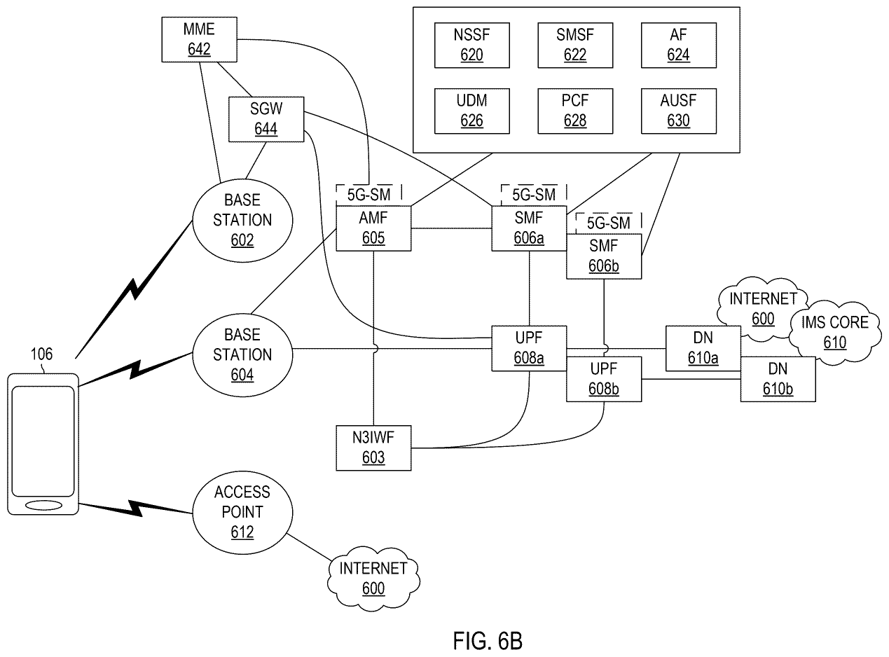

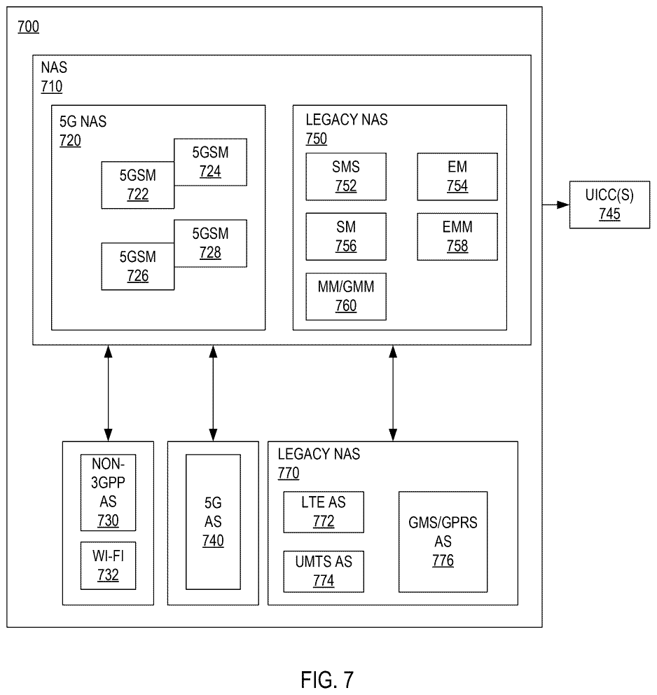

FIGS. 6A, 6B and 7: 5G Core Network Architecture—Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. In addition, the 5G CN may support dual-registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may include one or more functional entities associated with the 5G CN (e.g., NSSF 620, SMSF 622, AF 624, UDM 626, PCF 628, and/or AUSF 630). Note that UDM 626 may also include a home subscriber server (HSS) function and the PCF may also include a policy and charging rules function (PCRF). Note further that these functional entities may also be supported by the SMF 606a and the SMF 606b of the 5G CN. The AMF 605 may be connected to (or in communication with) the SMF 606a. Further, the gNB 604 may in communication with (or connected to) the UPF 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods for AI based CSI feedback with CSI prediction, including systems, methods, and mechanisms for a UE to indicate a predicted CSI report, network configuration of CSI feedback, UE PMI report format, and AI model life cycle management, e.g., in 5G NR systems and beyond, e.g., as further described herein.

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). The baseband processor architecture 700 can be in communication with one or more UICC(s) 745. Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

Note that in various embodiments, one or more of the above-described functional entities of the 5G NAS and/or 5G AS may be configured to perform methods for AI based CSI feedback with CSI prediction, including systems, methods, and mechanisms for a UE to indicate a predicted CSI report, network configuration of CSI feedback, UE PMI report format, and AI model life cycle management, e.g., in 5G NR systems and beyond, e.g., as further described herein.

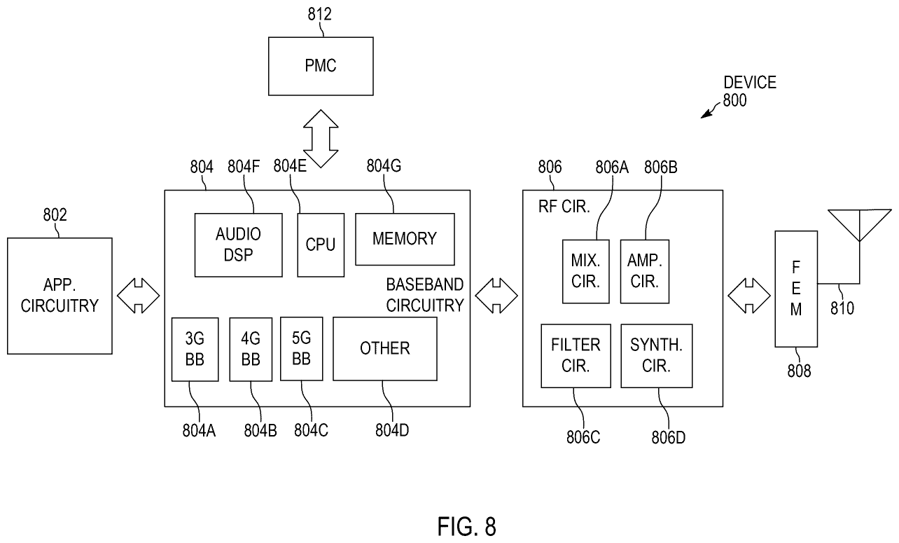

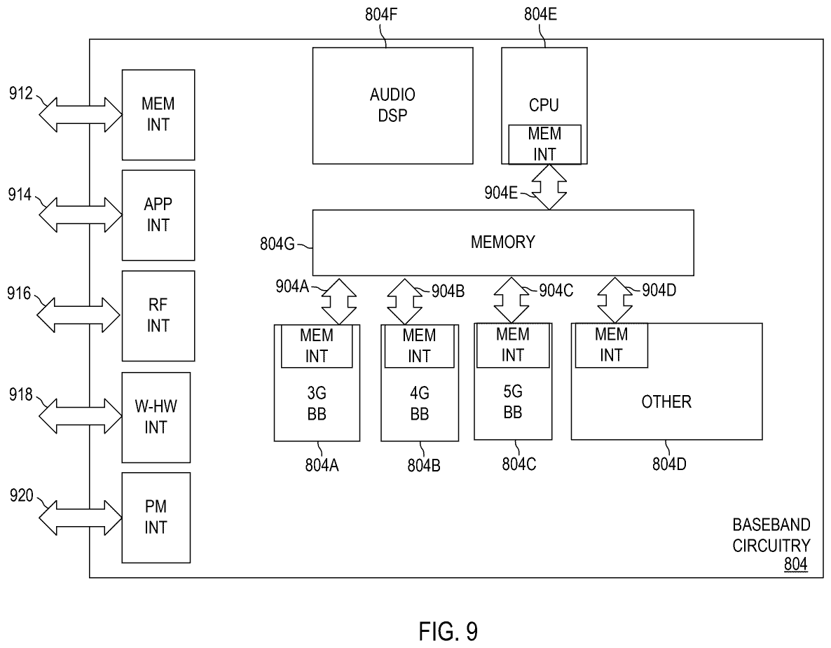

### FIGS. 8 and 9: Baseband Circuitry and Example Interfaces

FIG. 8 illustrates example components of a device 800 in accordance with some embodiments. In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a UE or a RAN node. In some embodiments, the device 800 may include less elements (e.g., a RAN node may not utilize application circuitry 802, and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuitry 804 may interface with the application circuitry 802 for generation and processing of the baseband signals and for controlling operations of the RF circuitry 806. For example, in some embodiments, the baseband circuitry 804 may include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), si8h generation (6G), etc.). The baseband circuitry 804 (e.g., one or more of baseband processors 804A-D) may handle various radio control functions that enable communication with one or more radio networks via the RF circuitry 806. In other embodiments, some or all of the functionality of baseband processors 804A-D may be included in modules stored in the memory 804G and executed via a Central Processing Unit (CPU) 804E. The radio control functions may include, but are not limited to, signal modulation/demodulation, encoding/decoding, radio frequency shifting, etc. In some embodiments, modulation/demodulation circuitry of the baseband circuitry 804 may include Fast-Fourier Transform (FFT), precoding, or constellation mapping/demapping functionality. In some embodiments, encoding/decoding circuitry of the baseband circuitry 804 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804F. The audio DSP(s) 804F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide for communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806A, amplifier circuitry 806B and filter circuitry 806C. In some embodiments, the transmit signal path of the RF circuitry 806 may include filter circuitry 806C and mixer circuitry 806A. RF circuitry 806 may also include synthesizer circuitry 806D for synthesizing a frequency for use by the mixer circuitry 806A of the receive signal path and the transmit signal path. In some embodiments, the mixer circuitry 806A of the receive signal path may be configured to down-convert RF signals received from the FEM circuitry 808 based on the synthesized frequency provided by synthesizer circuitry 806D. The amplifier circuitry 806B may be configured to amplify the down-converted signals and the filter circuitry 806C may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a necessity. In some embodiments, mixer circuitry 806A of the receive signal path may comprise passive mixers, although the scope of the embodiments is not limited in this respect.

In some embodiments, the mixer circuitry 806A of the transmit signal path may be configured to up-convert input baseband signals based on the synthesized frequency provided by the synthesizer circuitry 806D to generate RF output signals for the FEM circuitry 808. The baseband signals may be provided by the baseband circuitry 804 and may be filtered by filter circuitry 806C.

In some embodiments, the mixer circuitry 806A of the receive signal path and the mixer circuitry 806A of the transmit signal path may include two or more mixers and may be arranged for quadrature downconversion and upconversion, respectively. In some embodiments, the mixer circuitry 806A of the receive signal path and the mixer circuitry 806A of the transmit signal path may include two or more mixers and may be arranged for image rejection (e.g., Hartley image rejection). In some embodiments, the mixer circuitry 806A of the receive signal path and the mixer circuitry 806A may be arranged for direct downconversion and direct upconversion, respectively. In some embodiments, the mixer circuitry 806A of the receive signal path and the mixer circuitry 806A of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806D may be a fractional-N synthesizer or a fractional N/N+1 synthesizer, although the scope of the embodiments is not limited in this respect as other types of frequency synthesizers may be suitable. For example, synthesizer circuitry 806D may be a delta-sigma synthesizer, a frequency multiplier, or a synthesizer comprising a phase-locked loop with a frequency divider.

The synthesizer circuitry 806D may be configured to synthesize an output frequency for use by the mixer circuitry 806A of the RF circuitry 806 based on a frequency input and a divider control input. In some embodiments, the synthesizer circuitry 806D may be a fractional N/N+1 synthesizer.

In some embodiments, frequency input may be provided by a voltage controlled oscillator (VCO), although that is not a requirement. Divider control input may be provided by either the baseband circuitry 804 or the applications processor 802 depending on the desired output frequency. In some embodiments, a divider control input (e.g., N) may be determined from a look-up table based on a channel indicated by the applications processor 802.

Synthesizer circuitry 806D of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806D may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804. However, in other embodiments, the PMC 812 may be additionally or alternatively coupled with, and perform similar power management operations for, other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC_Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

If there is no data traffic activity for an extended period of time, then the device 800 may transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state, in order to receive data, it can transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 802 and processors of the baseband circuitry 804 may be used to execute elements of one or more instances of a protocol stack. For example, processors of the baseband circuitry 804, alone or in combination, may be used to execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below. Accordingly, the baseband circuitry 804 can be used to encode a message for transmission between a UE and a gNB, or decode a message received between a UE and a gNB.

FIG. 9 illustrates example interfaces of baseband circuitry in accordance with some embodiments. As discussed above, the baseband circuitry 804 of FIG. 8 may comprise processors 804A-804E and a memory 804G utilized by said processors. Each of the processors 804A-804E may include a memory interface, 904A-904E, respectively, to send/receive data to/from the memory 804G.

The baseband circuitry 804 may further include one or more interfaces to communicatively couple to other circuitries/devices, such as a memory interface 912 (e.g., an interface to send/receive data to/from memory e8ernal to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

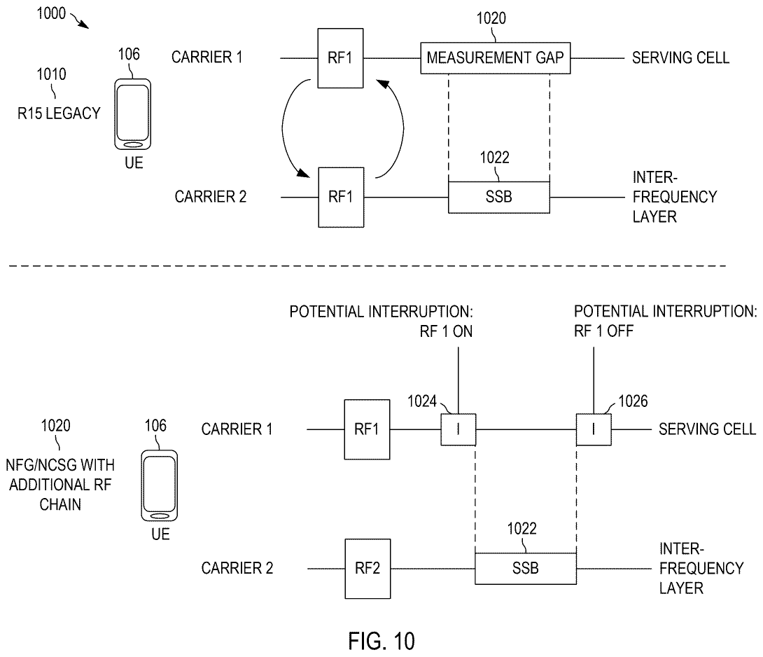

### FIG. 10: Schematic Bandwidth Diagram in the Frequency Domain

FIG. 10 illustrates an illustration of bandwidth diagrams 1010 and 1020 in the frequency domain, according to some example embodiments, comparing a legacy gap-based and an enhanced gapless approaches for inter-frequency RRM measurements by a UE using Need For Gaps (NFG) and Network Controlled Small Gap (NCSG) introduced in 3GPP Rel-16 and Rel-17. As depicted in FIG. 10, legacy approach 1010 illustrates using a measurement gap to measure a target SSB 1022, as used in 3GPP Rel-15, while the bottom portion 1020 shows an enhanced approach 1020 using Need For Gaps (NFG) or Network Controlled Small Gaps (NCSG) to measure the target SSB 1022 with no gap, as introduced in 3GPP Rel-16 and Rel-17.

In the legacy approach 1010, UE 106 has a single radio frequency (RF) chain, RF1. In the legacy approach 1010, the UE 106 has a single RF chain tuned to the serving cell carrier (e.g., carrier 1). However, a target SSB in a target frequency band is on a different carrier frequency band (e.g., carrier 2). The UE 106 is configured to perform inter-frequency RRM measurements on the target frequency carrier 2. This involves measuring the target synchronization signal block (SSB) 1022 transmitted on carrier 2. To perform inter-frequency RRM measurements on a different carrier frequency (e.g., carrier 2), the UE 106 is configured with periodic measurement gaps 1020 where the UE 106 temporarily stops communication on the serving cell carrier (e.g., carrier 1). That is, to measure the SSB 1022 on carrier 2, the UE 106 is configured with periodic measurement gaps 1024 where it temporarily stops communication on carrier 1.

During these measurement gaps 1024, the UE redirects its single RF chain to switch reception from the frequency range of carrier 1 to the frequency range of carrier 2 in order to receive and measure SSB 1022 for inter-frequency RRM measurements. The frequency range of carrier 2 may be a different frequency band from carrier 1, or a different channel within the same band as carrier 1. The need to periodically switch the RF chain reception between carrier 1 and carrier 2 to measure the target SSB 1022, along with stopping receive operations during the gaps 1024, interrupts active communication. The frequency gap also complicates scheduling at the gNB and the network, since the UE cannot be scheduled for uplink transmissions or downlink transmissions during the frequency gap period. The frequency gap period can be a relatively long period, often around 5 to 6 milliseconds.

In the enhanced approach 1020 using NFG/NCSG, the UE 106 is equipped with a second RF chain (e.g., RF2), in addition to RF1. By using one RF chain for receiving the serving cell using carrier 1 and another dedicated RF chain for receiving the inter-frequency signal using carrier 2, the UE can perform inter-frequency RRM measurements of the target SSB without the use of measurement gaps that would interrupt the serving cell communication and complicate NW scheduling. For inter-frequency RRM measurements, the UE 106 is configured to receive and measure the target SSB 1022 transmitted on target frequency carrier 2, while still communicating with the serving cell on carrier 1. With NFG/NCSG, the UE can achieve this without measurement gaps. A “Potential Interruption: RF 1 ON” 1024 depicts the RF1 remaining continuously configured to receive on carrier 1 for serving cell communication. That is, the RF1 remains continuously configured to receive on the carrier 1 frequency for serving cell communication, as shown by “Potential Interruption: RF 1 ON 1024”. In one example, carrier 1 reception by the first RF chain RF1 for the serving cell can be ongoing without any scheduled interruptions or gaps by the gNB or NW. In another embodiment, RF1 can be dynamically reconfigured during the measurement intervals to switch its reception to carrier 2 to receive and measure the SSB 1022, as depicted by “Potential Interruption: RF 1 OFF 1026”. That is, the “Potential Interruption: RF 1 OFF” 1026 depicts RF1 also switching to receive on carrier 2 during the measurement intervals to receive and measure the target SSB 1022 without interrupting communication on carrier 1. By using NFG/NCSG, no measurement gaps are needed and the UE 106 can receive both carriers 1 and 2 to maintain serving cell communication and perform inter-frequency RRM measurements. The UE can indicate this NFG/NCSG gapless measurement capability to the network using radio resource control (RRC) signaling. This will be discussed more fully in the proceeding paragraphs.

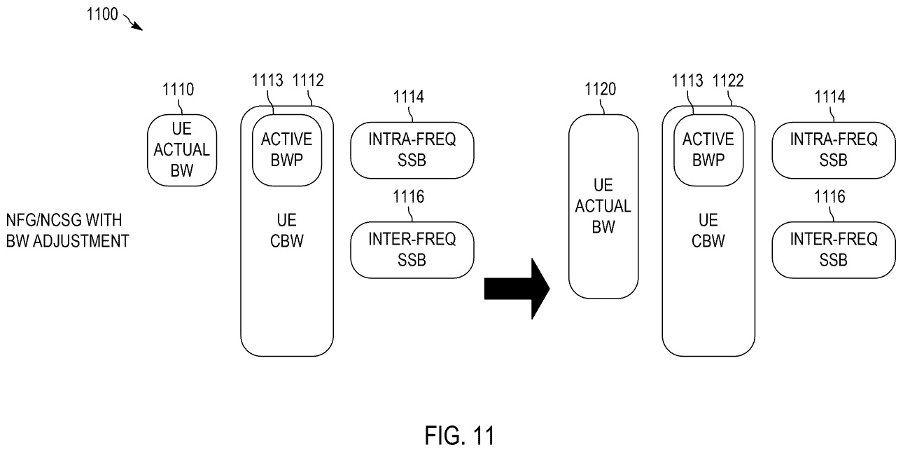

FIG. 11: Bandwidth Diagram of UE with Adjustable Bandwidth

FIG. 11 illustrates an example schematic bandwidth diagram 1100 of adjusting a UE bandwidth for gapless inter-frequency RRM measurements using NFG/NCSG according to some embodiments. In this example, it may be considered that the bandwidth diagram 1100 is illustrating a downlink (DL) bandwidth on which the gNB 120A is transmitting and the UE 110 is receiving. However, an uplink (UL) diagram would be similar to the DL bandwidth diagram 1100, except that the UE 110 would be transmitting on the UL frequencies and the gNB 120A would be receiving. In addition, the types of signals transmitted/received in the DL and UL may be different.

Initially (on the left side of the arrow depicted for illustration purposes only), the bandwidth diagram 1100 shows channel bandwidth CBW 1112 of a UE (e.g., UE 106 of FIG. 1A-1B). Typically, in 5G networks, the CBW is a maximum transmission bandwidth (defined in terms of resource blocks (RBs) and guard bands on both ends of the frequency spectrum (defined in terms of kHz). However, the CBW 1112 may be any group of contiguous frequencies. An active BWP 1113 frequency is defined within the CBW 1112. The active BWP 1113 is a set of contiguous frequencies within the CBW 1112 that is configured for a UE. Multiple UEs may be configured with the same active BWP 1113. A UE (e.g., UE 106) may be configured to receive Physical Downlink Shared Channel (PDSCH) transmissions, Physical Downlink Control Channel (PDCCH) transmissions, Channel State Information Reference Signals (CSI-RS), and Tracking Reference Signals (TRS) in the configured active BWP 1113. Another manner of stating this is that the UE 106 does not expect to receive these signals outside of the active BWP 1113. The UE actual BW 1110 is the active bandwidth that the UE is configured for, or capable of, for communication.

It should be noted than an SSB frequency band may be defined within the CBW 1112. Multiple SSBs may be configured for a UE. An intra-frequency synchronization signal block “SSB” 1114 is depicted and is an SSB transmitted on the same carrier frequency as the active BWP 1113 of the UE 106. The intra-frequency SSB 1114 may contain synchronization signals, broadcast information, and reference signals used by the UE for beam management, beam failure detection, and other radio resource management (RRM) measurements on its serving cell carrier. The intra-frequency SSB 1114 is configured for layer 1 RRM measurements by the UE on the active intra-frequency carrier.

The inter-frequency SSB 1116 is a synchronization signal block transmitted on a different carrier frequency compared to the as the actual BW 1110 of the UE 106. The inter-frequency SSB 1116 may contain synchronization signals, broadcast information, and reference signals used by the UE for inter-frequency neighbor cell search and measurements. The inter-frequency SSB 1116 is configured for layer 1 inter-frequency RRM measurements by the UE to detect and measure neighbor cells on other frequency carriers that can be used in carrier aggregation (CA). As depicted on the left side of the arrow, the inter-frequency SSB 1116 is located outside of the active BWP 1113 of the UE CBW 1112.

On the left side of the arrow in FIG. 11, the UE 106 has a CBW 1112 which is the total bandwidth that the UE 106 can support. The active BWP 1113 is configured within the CBW 1112 for active communication. The intra-frequency SSB 1114 is configured on the same frequency carrier as the active BWP 1113.

Without adjusting the bandwidth, the UE 106 would need a measurement gap to measure the inter-frequency SSB 1116 located outside its active BWP 1113. To enable gapless inter-frequency RRM measurement, the UE 106 may enlarge its receiver bandwidth from only receiving within active BWP 1113 to now receiving over a wider actual bandwidth (e.g., the UE actual BW 1120), which also covers the inter-frequency SSB 1116, as shown on the right side of FIG. 11. When not the measuring inter-frequency SSB 1116, the UE 106 may be configured to reduce its actual bandwidth 1120 back to a smaller bandwidth, to only receiving within the active BWP 1113, excluding the inter-frequency SSB 1116. In other words, the UE actual bandwidth 1120 may be periodically adjusted between the UE actual bandwidth 1110 on the left side of FIG. 11 to the UE actual bandwidth 1120 on the right side of FIG. 11, and then back.

Thus, as depicted herein, the UE 106 may use a larger bandwidth, e.g., the UE actual BW 1120, to cover the target SSB (e.g., inter-frequency SSB 1116) and the UE active BWP 1113. The UE actual BW 1110 may be set to the CBW 1112. As shown in FIG. 11, the UE 106 may periodically change the UE actual

BW 1113 to use a larger bandwidth, e.g. increase the UE actual BW 1113, to cover a target SSB and the UE active BWP 1113, and change the UE actual BW 1113 to use a smaller bandwidth, e.g. decrease the UE actual BW 1113, to include the UE active BWP 1113 and exclude the target SSB (e.g., inter-freq SSB 1116). Reducing the size of the UE actual bandwidth can provide significant power savings to the UE 106.

Because the UE 106 may use the larger bandwidth, the UE 106 may not need to tune away (e.g., have a measurement gap or no-gap), and may not need interruption (e.g., have a measurement interruption or no-interruption), to perform inter-frequency RRM measurements on a target SSB 1022 that is outside the active BWP 1113. In addition, because the UE 106 may periodically or occasionally switch between larger (1120) and smaller (1110) bandwidths, the UE 106 may not need to tune away (e.g., have a measurement gap or no-gap), but may need an interruption (e.g. have a measurement interruption or with-interruption), to perform inter-frequency RRM measurements on a target SSB 1116 that is outside the active BWP 1113.

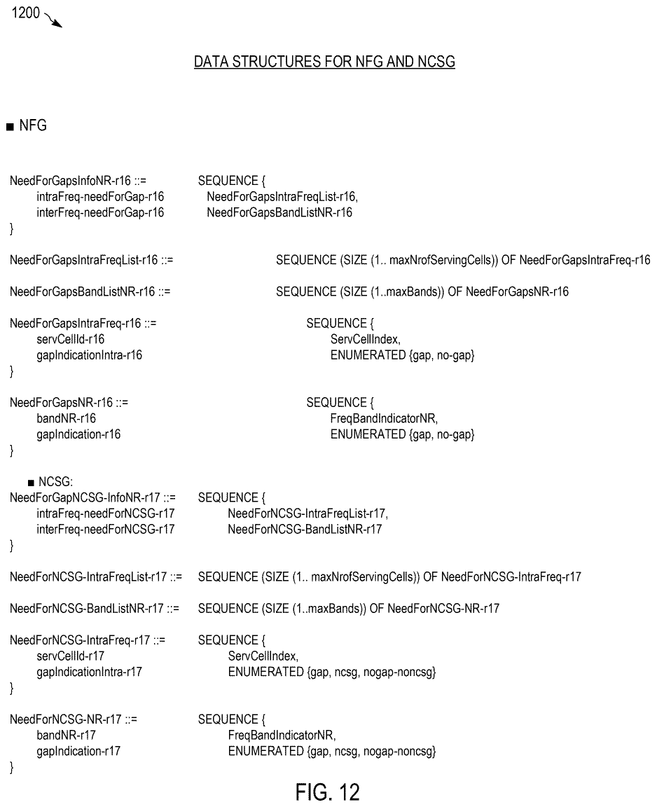

### FIG. 12: Data Structures for NFG and NCSG

FIG. 12 illustrates data structures 1200 for NFG and NCSG for 3GPP Release 16 and Release 17 in an ASN.1 format containing 3GPP protocol elements for indicating UE support for inter-frequency RRM measurements without gaps using NFG and NCSG according to some embodiments. As shown, support for NFG and NCSG is indicated separately for intra-frequency and inter-frequency scenarios.

For inter-frequency support, NFG and NCSG capabilities are indicated per frequency band. The UE can report an NFG or NCSG capability parameter for each supported band. The ‘NeedForGapsNR-r16’ IE depicts the NFG capability indication per band for a UE configured for NR based on 3GPP Release 16. The per band NFG capability is indicated using a ‘gapIndication’ parameter. The UE can report ‘gap’ or ‘no-gap’ for each band to indicate if gapless inter-frequency RRM measurement are supported using NFG in one or more frequency bands.

Similarly, the ‘NeedForNCSG-NR-r17’ IE shows the NCSG capability indication per band, using the gapIndication parameter for UEs configured for NR based on 3GPP Release 17. The UE can report ‘gap’, ‘ncsg’, or ‘nogap-noncsg’ for each band to indicate if gapless inter-frequency RRM measurement is supported using NCSG.

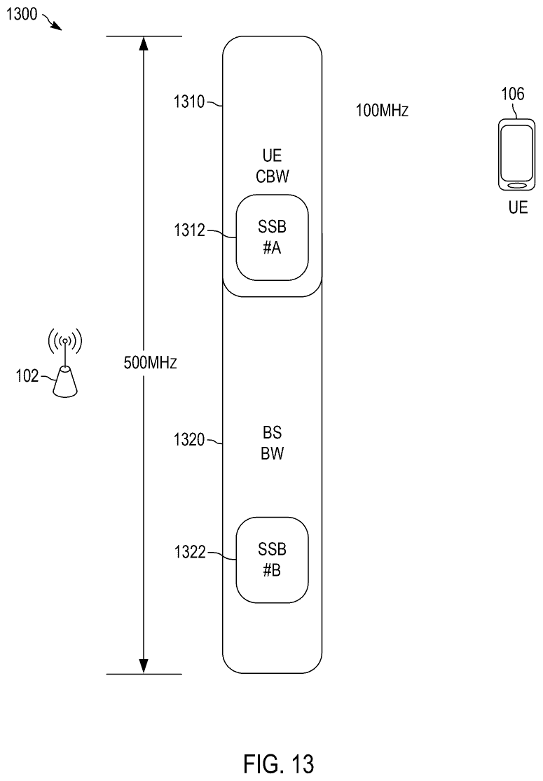

FIG. 13 illustrates an example schematic diagram 1300 of frequency allocation where only a portion of the band can be measured gapless by the UE for inter-frequency RRM measurements using NFG or NCSG according to some embodiments. More specifically, FIG. 13 depicts one challenge faced by a UE that can only support NFG or NCSG for inter-frequency RRM measurements in a portion of a band. That is, if a UE intends to support gapless measurement (e.g., NFG or NCSG) for an inter-frequency target SSB in a target band, the UE is configured to support gapless measurement on all neighbor cells across the entire band of the BS 102. As shown, a base station 102 may transmit SSBs across its entire transmission bandwidth. However, the UE 106 has a limited channel bandwidth (CBW) 1310 that is smaller than the base station bandwidth (e.g., BS BW 1320). In FIG. 13, SSB #A 1312 at a first frequency is within the CBW 1310 of the UE 106. If the UE 106 does not have an additional RF chain, the UE 106 can adjust its channel bandwidth 1310 to cover SSB #A 1312 (or SSB #A may already be within an active BWP of the UE) and execute gapless measurement to measure the SSB using NFG/NCSG. However, SSB #B 1322 is at a different frequency and is outside the CBW 1310 of the UE 106. The UE 106 would need a measurement gap to measure the SSB #B.

According to current standards, if the UE 106 can only support NFG or NCSG for inter-frequency measurements within a portion of the band, the UE 106 should not indicate support for the entire band. Therefore, even though the UE 106 can measure SSB #A with no gap using NFG or NCSG, the UE 106 cannot indicate NFG/NCSG support for this band since SSB #B falls outside of the UE bandwidth 1310. These constraints can limit a UE's ability to perform gapless measurements of target SSBs.

In accordance with one embodiment, new parameters can be introduced in which a UE can provide more detailed capability information regarding the UE's ability to perform gapless measurements. Instead of limiting the ability of a UE to only provide a no-gap indication (and noNCSG indication) when the UE can support NFG or NCSG for inter-frequency measurement within the entire target band, the UE can provide conditions that inform the gNB of the UE's capabilities to perform no-gap measurements under certain conditions. These conditions can be communicated to the gNB in a manner similar to the parameter communication illustrated in FIG. 12.

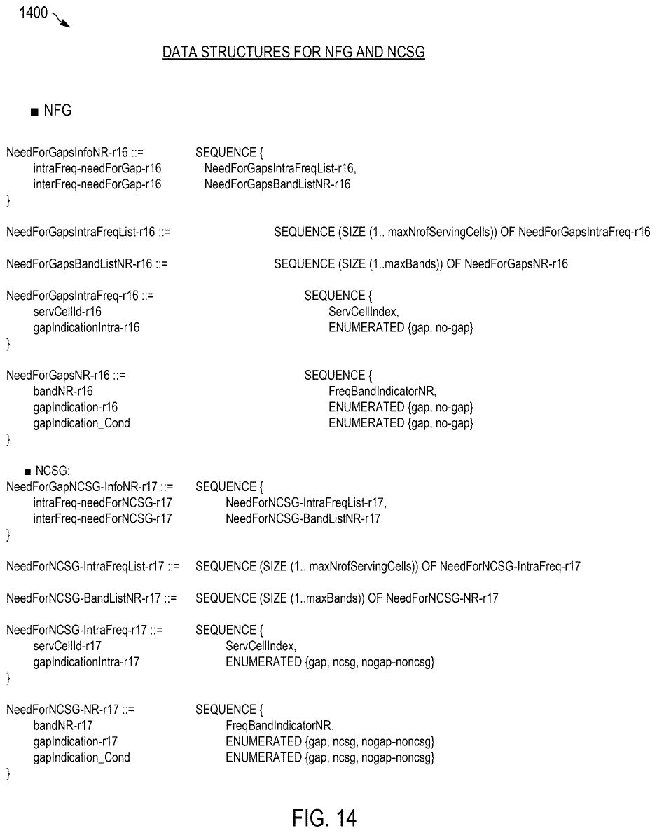

FIG. 14: Data Structures for NFG and NCSG with Conditional Parameters

FIG. 14 illustrates example data structures 1400 for NFG and NCSG, with the introduction of new gap indication parameters in 3GPP protocols to indicate conditional UE support for inter-frequency RRM measurements without gaps using NFG and NCSG. FIG. 14 illustrates a solution to the challenge presented in FIG. 13 by providing new indication parameters in 3GPP protocols that enable the UE to indicate gapless measurement (e.g., NFG/NCSG) support for inter-frequency RRM measurements, which may be under one or more conditions.

As depicted, new ‘gapIndication_Cond’ parameters can be introduced in the ‘NeedForGapsNR’ and ‘NeedForNCSG-NR’ IEs used to indicate inter-frequency capability per band for UEs configured for 3GPP Release 16 or Release 17, as indicated. This allows the UE to provide a more granular, conditional NFG capability indication using a ‘gapIndication_Cond’ parameter, separate from the legacy ‘gapIndication’ parameter which indicates general capability for the entire band. Similarly, a conditional NCSG capability can be indicated using the new ‘gapIndication_Cond’ parameter in the ‘NeedForNCSG-NR’ IE. By introducing these new conditional parameters, the UE can indicate NFG/NCSG support limited to only a portion of the band, while still utilizing legacy parameters to indicate general capability for the entire band.

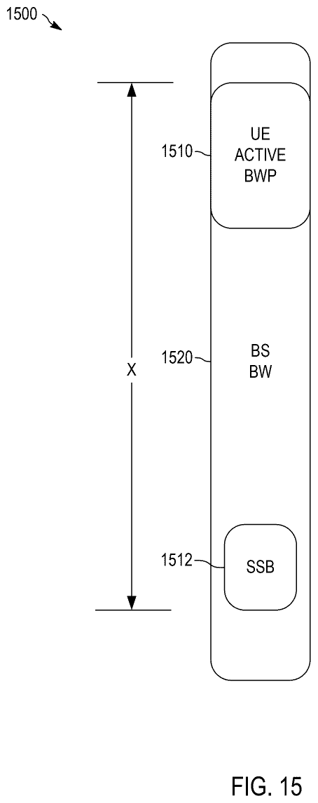

FIG. 15: Bandwidth Diagram with Configurable Frequency Separation

FIG. 15 illustrates an example schematic bandwidth diagram 1500 of a configurable frequency separation threshold between an active BWP and SSB target for conditional inter-frequency RRM measurement support using NFG/NCSG, as illustrated in FIG. 14.

As shown, the base station bandwidth 1520 covers the entire frequency span. The UE's CBW is configured within the base station bandwidth (BS BW) 1520. Within the UE's CBW, a UE active bandwidth part (BWP) 1510 is configured. The UE 106 actively receives data and control information on the BWP 1512 frequency band. A target SSB 1512 is also shown, configured at a specific frequency within the BS BW 1520. This target SSB 1510 can be measured by the UE for inter-frequency RRM purposes.

There is a frequency separation, designated as “X”, between the center of the active BWP 1510 and the target SSB 1512. In one embodiment, the frequency separation is defined as a contiguous frequency range in the frequency domain which fully contains bandwidth of a target SSB and bandwidth of the active BWP. The UE 106 can indicate conditional support for inter-frequency gapless RRM measurement of target SSB 1512 if this frequency separation X is within a configured threshold (i.e. a capability of the UE). The frequency separation threshold value, “X”, can be specified in different ways.

In one embodiment, a first condition (e.g., Option 1), the target SSB 1512 to measure may be within a UE's channel bandwidth (CBW). If the target SSB 1512 is within the UE's CBW, the UE 106 can execute gapless measurement by increasing a receive bandwidth of the UE 106.

In a second condition (e.g., option 2), the frequency separation between the target SSB 1512 and the active BWP 1510 is within a certain threshold value, X. The value of X can be indicated by a UE, indicating the capability of the UE to increase the UE's actual bandwidth to include both the active BWP 15120 and the target SSB 1512. If the target SSB 1512 is within a certain frequency separation from the active BWP 1510, the UE 106 can execute gapless measurement by increasing by changing the UE's actual bandwidth. In one example, multiple options can be used for configuring the frequency separation threshold X. That is, the UE 106 can indicate its capability in terms of the frequency separation it can support between the active BWP 1510 and the target SSB 1512 for gapless inter-frequency RRM measurement. In one embodiment, the data structures 1400 (FIG. 14) can provide predetermined bands that the UE can from to indicate the UE's capability. For instance, the UE can select from options for the frequency separation value X such as, for example, 50 MHz, 100 MHz, 200 MHz, 400 MHz etc. This example is not intended to be limiting. The separation value may include even greater separation values that may be used in frequency range 2 (FR2).

For example, the second condition may include the following conditions. In one example of the second condition (e.g., option 2a), the frequency separation threshold X is indicated based on UE 109 capability in terms of supported frequency separation such as, for example, 50 Megahertz (MHz), 100 MHz, 200 MHz, or 400 MHz. The UE can report one or more of these options depending on its capability (e.g., total UE CBW). Since the frequency separation capability can vary with subcarrier spacing (SCS), the UE can indicate different X values of the frequency separation threshold for different SCS configurations where the different X values can be reported per UE, frequency range, per bandwidth, or per bandwidth per bandwidth combination.

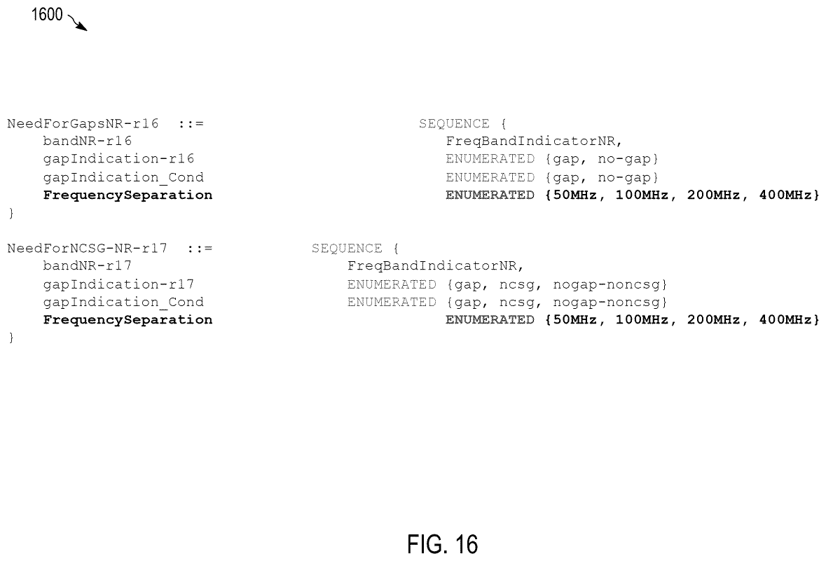

FIG. 16: Data Structures for NFG and NCSG with Conditional Parameters

In another example, in a second condition (e.g., option 2b), the frequency separation threshold X value can be indicated in a new IE in NFG or NCSG feedback from the UE 106, such as an additional parameter in the example of FIG. 14. This second condition is depicted in FIG. 16 by a data structure 1600 for NFG and NCSG that is illustrated as an example in an ASN.1 format.

In another example, in the second condition (e.g., option 2c), the frequency separation threshold X value can be predefined in a specification based on a UE configuration such as, for example, for a selected subcarrier spacing, with a single component carrier, for carrier aggregation, and/or bandwidth class etc. By defining conditions based on SSB location and frequency separation, the UE can accurately indicate its conditional capability for gapless inter-frequency measurement.

Moreover, one or more rules are defined for reporting the newly introduced gapless measurement indication (e.g., ‘gapIndication_Cond) along with an existing legacy ‘gapIndication’ parameter. These rules align the values indicated across these two parameters.

For NFG, if the UE 106 indicates a ‘gap’ value for the ‘gapIndication_Cond’ parameter, it shall only indicate ‘gap’ for the legacy gapIndication parameter. If the UE 106 indicates a ‘no-gap’ value for the ‘gapIndication_Cond’ parameter, the UE 106 is allowed to indicate either ‘gap’ or ‘no-gap’ for the legacy ‘gapIndication’ parameter.

For NCSG, if the UE 106 indicates a ‘gap’ value for the ‘gapIndication_Cond’ parameter, the UE 106 shall only indicate ‘gap’ for the legacy gapIndication parameter. If the UE 106 indicates a ‘ncsg’ value for the ‘gapIndication_Cond’ parameter, the UE 106 shall only indicate either ‘gap’ or ‘ncsg’ for the legacy ‘gapIndication’ parameter.

If the UE indicates a ‘nogap-noncsg’ value for the ‘gapIndication_Cond’ parameter, the UE 106 can to indicate any value for the legacy ‘gapIndication’ parameter. Let me know if this helps explain the reporting rules proposed for consistency between the ‘gapIndication_Cond’ and legacy gapIndication parameters.

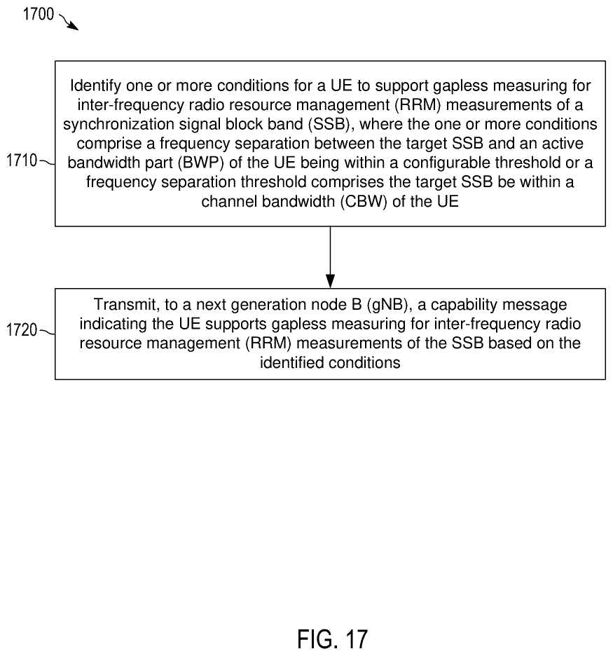

### FIG. 17: Method for Determining a Measurement Gap Configuration

FIG. 17 illustrates a block diagram of an example of a method 1700 for determining a measurement gap configuration for RRM measurements according to some embodiments. The method 1700, illustrated in the example of FIG. 17, may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1710, a UE may identify one or more conditions for a UE to support gapless measuring for inter-frequency radio resource management (RRM) measurements of a synchronization signal block band (SSB), where the one or more conditions comprise a frequency separation between the target SSB and an active bandwidth part (BWP) of the UE being within a configurable threshold or a frequency separation threshold comprises the target SSB be within a channel bandwidth (CBW) of the UE. The frequency separation is defined as a contiguous frequency range in the frequency domain which fully contains bandwidth of a target SSB and bandwidth of the active BWP.

At 1720, the UE may transmit, to a next generation node B (gNB), a capability message indicating the UE supports gapless measuring for inter-frequency radio resource management (RRM) measurements of the SSB based on the identified conditions.

In some embodiments, the frequency separation threshold is a specified frequency separation of one or 50 Megahertz (MHz), 100 MHz, 200 MHz, or 400 MHz frequency separation based on a capability of the UE. In some embodiments, the frequency separation threshold is specified in a measurement gap parameter value, wherein the measurement gap parameter value is a gap indication conditional (gapIndication_Cond) parameter in a need for gaps information element (IE).

In some embodiments, the frequency separation threshold is configured for a selected frequency band. In some embodiments, the frequency separation threshold is configured for a frequency range. In other embodiments, the frequency separation threshold is pre-defined based on at least one of subcarrier spacing (SCS), a single component carrier, carrier aggregation, or bandwidth class.

In some embodiments, the UE can indicate a ‘gap’ value for a ‘gapIndication_Cond’ parameter for a Need For Gap (NFG) configuration to indicate the UE supports gapless measuring using NFG, where the UE indicates only ‘gap’ in a gapIndication parameter based on the ‘gap’ value in the ‘gapIndication_Cond’ parameter. In some embodiments, the UE can indicate a ‘no-gap’ value for a ‘gapIndication_Cond’ parameter for a Need For Gap (NFG) configuration to indicate the UE supports gapless measuring using NFG, wherein the UE indicates either ‘gap’ or ‘no-gap’ in a gapIndication parameter based on the ‘no-gap’ value in the ‘gapIndication_Cond’ parameter.

In some embodiments, the UE can indicate a ‘ncsg’ value for a ‘gapIndication_Cond’ parameter for a Network Controlled Small Gap (NCSG) configuration to indicate the UE supports gapless measuring using NCSG, wherein the UE indicates either ‘gap’ or ‘ncsg’ in a gapIndication parameter based on the ‘ncsg’ value in the ‘gapIndication_Cond’ parameter.

In some embodiments, the UE can indicate a ‘nogap-noncsg’ value for a ‘gapIndication_Cond’ parameter for a Network Controlled Small Gap (NCSG) configuration to indicate the UE supports gapless measuring using NCSG, wherein the UE indicates any value in a gapIndication parameter based on the ‘nogap-noncsg’ value in the ‘gapIndication_Cond’ parameter.

In some embodiments, mechanisms of the illustrated embodiments provide for a Next Generation NodeB (gNB) operable to assist with enhanced inter-frequency radio resource management (RRM) measurements by a user equipment (UE), the apparatus comprising one or more processors, coupled to a memory. The one or more processors configured to receive and/or decode, from the UE, a capability message indicating the UE supports gapless measuring for inter-frequency radio resource management (RRM) measurements of a target synchronization signal block band (SSB) based on the identified conditions, wherein the capability message indicates one or more conditions for the UE to support gapless measuring for inter-frequency RRM measurements of the target SSB, where the one or more conditions comprise a frequency separation between the target SSB and an active bandwidth part (BWP) being within a configurable threshold or a frequency separation threshold of the target SSB, wherein the BWP and the target SSB are within a channel bandwidth of the UE.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus of a user equipment (UE) configured to perform inter-frequency radio resource management (RRM) measurements, the apparatus comprising:
one or more processors, coupled to a memory, configured to:
identify one or more conditions for which the UE is configured to support gapless measuring for inter-frequency radio resource management (RRM) measurements of a target synchronization signal block band (SSB); and
transmit, to a next generation node B (gNB), a capability message indicating the UE supports gapless measuring for inter-frequency radio resource management (RRM) measurements of the target SSB based on the one or more identified conditions.

2. The apparatus of claim 1, wherein the one or more conditions comprise the support being limited to one or more portions of a frequency band.

3. The apparatus of claim 1, wherein the one or more conditions comprise a frequency separation between the target SSB and an active bandwidth part (BWP) of the UE being within a configurable threshold.

4. The apparatus of claim 3, wherein the frequency separation threshold comprises the target SSB to be within a channel bandwidth (CBW) of the UE.

5. The apparatus of claim 4, wherein the frequency separation threshold is a specified frequency separation of one of 50 Megahertz (MHz), 100 MHz, 200 MHz, or 400 MHz frequency separation based on a capability of the UE.

6. The apparatus of claim 3, wherein the frequency separation threshold is specified in a measurement gap parameter value, wherein the measurement gap parameter value is a gap indication conditional (gapIndication_Cond) parameter in a need for gaps information element (IE).

7. The apparatus of claim 3, wherein the frequency separation threshold is configured for a selected frequency band.

8. The apparatus of claim 3, wherein the frequency separation threshold is configured for a frequency range.

9. The apparatus of claim 3, wherein the frequency separation threshold is pre-defined based on at least one of subcarrier spacing (SCS), a single component carrier, carrier aggregation, or bandwidth class.

10. The apparatus of claim 1, wherein the one or more processors are further configured to indicate a ‘gap’ value for a ‘gapIndication_Cond’ parameter for a Need For Gap (NFG) configuration to indicate the UE supports gapless measuring using NFG, wherein the UE indicates only ‘gap’ in a gapIndication parameter based on the ‘gap’ value in the ‘gapIndication_Cond’ parameter.

11. The apparatus of claim 1, wherein the one or more processors are further configured to indicate a ‘no-gap’ value for a ‘gapIndication_Cond’ parameter for a Need For Gap (NFG) configuration to indicate the UE supports gapless measuring using NFG, wherein the UE indicates either ‘gap’ or ‘no-gap’ in a gapIndication parameter based on the ‘no-gap’ value in the ‘gapIndication_Cond’ parameter.

12. The apparatus of claim 1, wherein the one or more processors are further configured to indicate a ‘ncsg’ value for a ‘gapIndication_Cond’ parameter for a Network Controlled Small Gap (NCSG) configuration to indicate the UE supports gapless measuring using NCSG, wherein the UE indicates either ‘gap’ or ‘ncsg’ in a gapIndication parameter based on the ‘ncsg’ value in the ‘gapIndication_Cond’ parameter.

13. The apparatus of claim 1, wherein the one or more processors are further configured to indicate a ‘nogap-noncsg’ value for a ‘gapIndication_Cond’ parameter for a Network Controlled Small Gap (NCSG) configuration to indicate the UE supports gapless measuring using NCSG, wherein the UE indicates any value in a gapIndication parameter based on the ‘nogap-noncsg’ value in the ‘gapIndication_Cond’ parameter.

14. An apparatus of user equipment configured to enhance inter-frequency radio resource management (RRM) measurements, the apparatus comprising:
one or more processors, coupled to a memory, configured to:
identify one or more conditions for a UE to support gapless measuring for inter-frequency radio resource management (RRM) measurements of a target synchronization signal block band (SSB), wherein the one or more conditions comprise a frequency separation between the target SSB and an active bandwidth part (BWP) of the UE being within a configurable threshold or a frequency separation threshold comprises the target SSB be within a channel bandwidth (CBW) of the UE; and
transmit, to a next generation node B (gNB), a capability message indicating the UE supports gapless measuring for inter-frequency radio resource management (RRM) measurements of the SSB based on the identified conditions.

15. The apparatus of claim 14, wherein the frequency separation threshold is a specified frequency separation of one or 50 Megahertz (MHz), 100 MHz, 200 MHz, or 400 MHz frequency separation based on a capability of the UE.

16. The apparatus of claim 14, wherein the wherein the frequency separation threshold is specified in a measurement gap parameter value, wherein the measurement gap parameter value is a gap indication conditional (gapIndication_Cond) parameter in a need for gaps information element (IE).

17. The apparatus of claim 14, wherein the frequency separation threshold is configured for a selected frequency band.

18. The apparatus of claim 14, wherein the frequency separation threshold is configured for a frequency range or is pre-defined based on at least one of subcarrier spacing (SCS), a single component carrier, carrier aggregation, or bandwidth class.

19. (canceled)

20. The apparatus of claim 14, wherein the one or more processors are further configured to:
indicate a ‘gap’ value for a ‘gapIndication_Cond’ parameter for a Need For Gap (NFG) configuration to indicate the UE supports gapless measuring using NFG, wherein the UE indicates only ‘gap’ in a gapIndication parameter based on the ‘gap’ value in the ‘gapIndication_Cond’ parameter;
indicate a ‘no-gap’ value for a ‘gapIndication_Cond’ parameter for a Need For Gap (NFG) configuration to indicate the UE supports gapless measuring using NFG, wherein the UE indicates either ‘gap’ or ‘no-gap’ in a gapIndication parameter based on the ‘no-gap’ value in the ‘gapIndication_Cond’ parameter;
indicate a ‘ncsg’ value for a ‘gapIndication_Cond’ parameter for a Network Controlled Small Gap (NCSG) configuration to indicate the UE supports gapless measuring using NCSG, wherein the UE indicates either ‘gap’ or ‘ncsg’ in a gapIndication parameter based on the ‘ncsg’ value in the ‘gapIndication_Cond’ parameter; or
indicate a ‘nogap-noncsg’ value for a ‘gapIndication_Cond’ parameter for a Network Controlled Small Gap (NCSG) configuration to indicate the UE supports gapless measuring using NCSG, wherein the UE indicates any value in a gapIndication parameter based on the ‘nogap-noncsg’ value in the ‘gapIndication_Cond’ parameter.

21. (canceled)

22. (canceled)

23. (canceled)

24. (canceled)

25. An apparatus of a Next Generation NodeB (gNB) operable to assist with enhanced inter-frequency radio resource management (RRM) measurements by a user equipment (UE), the apparatus comprising:
one or more processors, coupled to a memory, configured to:
receive, from the UE, a capability message indicating the UE supports gapless measuring for inter-frequency radio resource management (RRM) measurements of a target synchronization signal block band (SSB) based on identified conditions, wherein the capability message indicates one or more conditions for the UE to support gapless measuring for inter-frequency RRM measurements of the target SSB, wherein the one or more conditions comprise a frequency separation between the target SSB and an active bandwidth part (BWP) being within a configurable threshold or a frequency separation threshold of the target SSB, wherein the BWP and the target SSB are within a channel bandwidth of the UE.

26. (canceled)

27. (canceled)
